(19) United States
(12) Patent Application Publication
(10) Pub. No.: US 2019/0360605 A1
(43) Pub. Date: Nov. 28, 2019

(54) FLUID FLOW REGULATOR WITH SWITCH

(71) Applicant: Hendrickson USA, L.L.C., Itasca, IL (US)

(72) Inventors: Matt J. Wilson, Canal Fulton, OH (US); Jesse W. Cervantez, Navarre, OH (US)

(21) Appl. No.: 16/411,368

(22) Filed: May 14, 2019

Related U.S. Application Data
(60) Provisional application No. 62/676,369, filed on May 25, 2018.

(51) Int. Cl. F16K 17/22; F16K 31/10; F16K 15/20; B60C 29/00

(52) U.S. Cl. CPC F16K 17/22; B60C 29/002; F16K 15/207; F16K 31/10

(57) ABSTRACT

A fluid flow regulator comprises a body, an actuatable switch, and valve structure. The valve structure is disposed within the body and has at least a portion movable between an actuating position and a non-actuating position. The actuating position actuates the switch. The non-actuating position does not actuate the switch.

### CROSS-REFERENCE TO RELATED APPLICATION

This application claims the benefit of U.S. Provisional Patent Application No. 62/676,369, filed May 25, 2018.

### BACKGROUND

The subject disclosure relates generally to fluid flow regulators. The subject disclosure relates in particular to a fluid flow regulator for use with a tire inflation system of a heavy-duty vehicle.

Tire inflation systems for heavy-duty vehicles are known. For the purpose of convenience, reference is made to a heavy-duty vehicle with the understanding that such reference includes a truck, tractor-trailer and semi-trailer, trailer, and the like. Heavy-duty vehicles typically employ multiple tires, each of which is inflated with air to a target pressure for optimal performance. If a tire is under-inflated, it is desirable to allow pressurized air to flow into that tire to inflate the tire and return it to or near the target pressure.

Tire inflation systems using mechanical and/or pneumatic components typically have a flow detection device, or flow switch, disposed within a fluid flow path of the tire inflation system. The flow detection device is activated when the tire inflation system is actively inflating tires. The flow detection device may include electrical contacts that close when the fluid flow exceeds a preset threshold rate. Closed contacts direct electrical power to another device, such as an indicator light, which illuminates. The illuminated indicator light informs an operator of the heavy-duty vehicle that the tire inflation system is actively supplying air to fill at least one tire. If the light remains illuminated for a relatively extended period of time, the heavy-duty vehicle operator should determine if inspection of the tires or tire inflation system components is warranted.

Prior art flow detection devices, while satisfactory for their intended functions, have disadvantages, drawbacks, and limitations. For example, some prior art flow detection devices are placed in the pressurized fluid flow path. As a result, the prior art flow detection devices tend to restrict fluid flow capacity of the tire inflation system. Increasing the flow sensitivity of prior art flow detection devices enables early detection of a leak but typically further restricts the flow capacity and increases the cost of the tire inflation systems. Thus, tire inflation systems using prior art flow detection devices compromise between system flow capacity and increased cost associated with flow sensitivity. In addition, components or contacts of the prior art flow detection devices may be directly exposed to moisture present in the fluid path. Moisture buildup on the components or contacts potentially cause the prior art flow detection devices to be unreliable and provide inaccurate readings. Thus, there is a need for an inexpensive flow detection device that provides tire inflation systems with increased sensitivity to fluid flow without limiting the flow capacity or accuracy and reliability of the system.

### SUMMARY

This summary is provided to introduce concepts disclosed in the description but is intended neither to identify key factors or essential features of the subject disclosure, nor to limit the scope of the subject disclosure.

A fluid flow regulator with a flow switch, constructed according to one aspect of the subject disclosure, overcomes the disadvantages, drawbacks, and limitations associated with prior art flow detection devices. The fluid flow regulator of the subject disclosure includes a body, a switch, and a valve structure. The valve structure is disposed within the body and has at least a portion that is movable between an actuating position and a non-actuating position. The switch is activated when the portion of the valve structure is in the actuating position. The switch is not activated when the portion of the valve structure is in the non-actuating position.

According to another aspect of the subject disclosure, a fluid flow regulator includes an externally disposed and directly-actuated switch, such as a proximity switch, linear variable differential transformer, optical coupler/encoder, microswitch, or integrated switch. The fluid flow regulator of the subject disclosure includes a switch with high flow capacity, increased sensitivity to relatively low fluid flow, and decreased cost.

According to yet another aspect of the subject disclosure, a fluid flow regulator includes a body, an actuatable switch, and a valve. The valve is disposed within the body and has a portion movable between a first position and a second position. When the portion of the valve is in the first position, the switch is not actuated. When the portion of the valve is in the second position, the switch is actuated.

### DESCRIPTION OF THE DRAWINGS

The following description and drawings set forth certain illustrative aspects and implementations of the subject disclosure. These are indicative of but a few of the various ways in which one or more aspects and implementations may be employed. Further features of the subject disclosure will become apparent to those skilled in the art to which the subject disclosure relates from reading the following description with reference to the accompanying drawings, in which:

FIG. 1 is a schematic illustration of a portion of a tire inflation system utilizing a prior art fluid flow regulator and switch system;

FIG. 2 is a schematic illustration of a portion of a tire inflation system incorporating a regulator having a directly-actuated switch system in one condition, according to one aspect of the subject disclosure;

FIG. 3 is a schematic illustration of a portion of the tire inflation system, similar to FIG. 2, with the directly-actuated switch system in another condition;

FIG. 4 is an enlarged cross-sectional view of the regulator of the tire inflation system illustrated in FIGS. 2-3 with the directly-actuated switch located external to the fluid path;

FIG. 5 is a schematic illustration of a portion of a tire inflation system with a regulator having an integrated switch system in one condition, according to another aspect of the subject disclosure;

FIG. 6 is a schematic illustration of a portion of the tire inflation system, similar to FIG. 5, with the integrated switch system in another condition;

FIG. 7 is an enlarged cross-sectional view of the regulator of the tire inflation system illustrated in FIGS. 5-6 with the integrated switch;

FIG. 8 is an enlarged cross-sectional view of the dashed-circled portion of the regulator illustrated in FIG. 7 with the integrated switch in one condition; and

FIG. 9 is an enlarged cross-sectional view of the regulator, similar to FIG. 8, with the integrated switch in another condition.

Similar reference characters are intended to identify similar parts throughout.

### DESCRIPTION

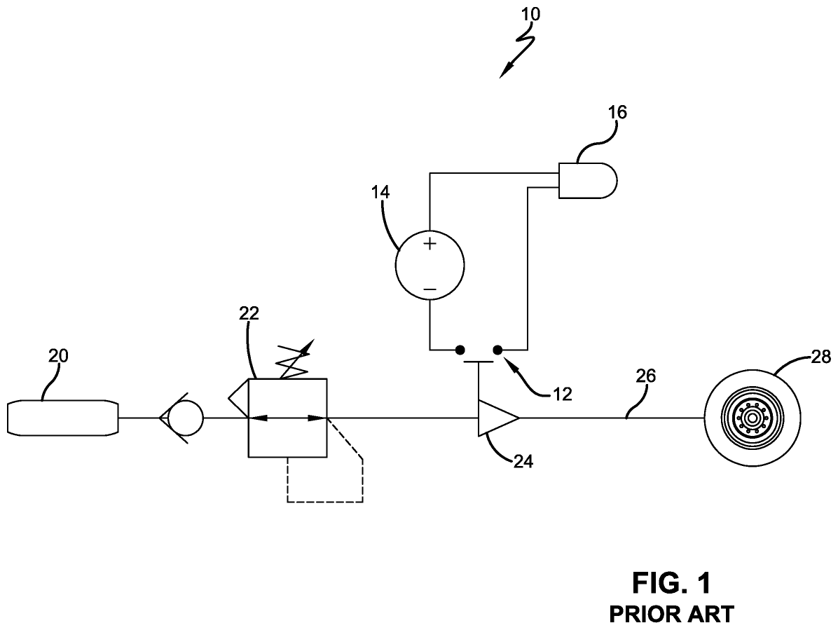

In order to better understand a fluid flow regulator with a flow switch of the subject disclosure and the environment in which it operates, components of a tire inflation system 10 having a prior art regulator 22 and a prior art in-line flow switch 24 are illustrated in FIG. 1. A source of fluid pressure 20 is in fluid communication with one or more tires 28 (only one shown) through a pressurized fluid path 26. The prior art regulator 22 and the prior art flow switch 24 are disposed within the fluid path 26 in fluid communication with the tires 28. The prior art flow switch 24 detects fluid flow through the fluid path 26.

The regulator 22 is generally employed to establish a target pressure, such as a minimum threshold pressure or an optimal pressure level, in the tires 28. The regulator 22 may be utilized to establish multiple target pressures, such as both the minimum threshold pressure and the optimal pressure level. This allows the regulator 22 to maintain fluid pressure in the tires 28 at a pressure level that reduces tire wear and extends tire life.

The prior art flow switch 24 is electrically connected to a normally-open switch or contacts 12. The contacts 12 are connected to a voltage source 14 and a lamp 16. The prior art flow switch 24 may have one or more preset threshold fluid flow rates. When fluid flow through the prior art flow switch 24 is at or above a predetermined threshold fluid flow rate, the contacts 12 closes. As a result, electrical power flows to the lamp 16, illuminating the lamp. When fluid flow through the prior art flow switch 24 is below the predetermined threshold fluid flow rate, contacts 12 opens, breaking the connection between the voltage source 14 and the lamp 16. As a result, the lamp 16 is no longer illuminated.

While satisfactory for its intended function, the prior art regulator 22 and in-line prior art flow switch 24 have disadvantages, drawbacks, and limitations. Specifically, the prior art flow switch 24 is disposed within the fluid path 26 between the source of fluid pressure 20 and the tires 28. As a result, the prior art flow switch 24 partially restricts or obstructs the fluid flow through the fluid path 26, reducing the flow capacity of the tire inflation system 10. Increasing the sensitivity of the prior art flow switch 24 generally results in increased restriction or obstruction of the fluid path 26 and increased cost due to additional components required to increase sensitivity. The placement of the flow switch 24 in the fluid path 26 may expose components of the flow switch to moisture. As a result, the prior art flow switch 24 may provide inaccurate readings. A regulator with directly-actuated or integrated switch of the subject disclosure overcomes these disadvantages, drawbacks, and limitations.

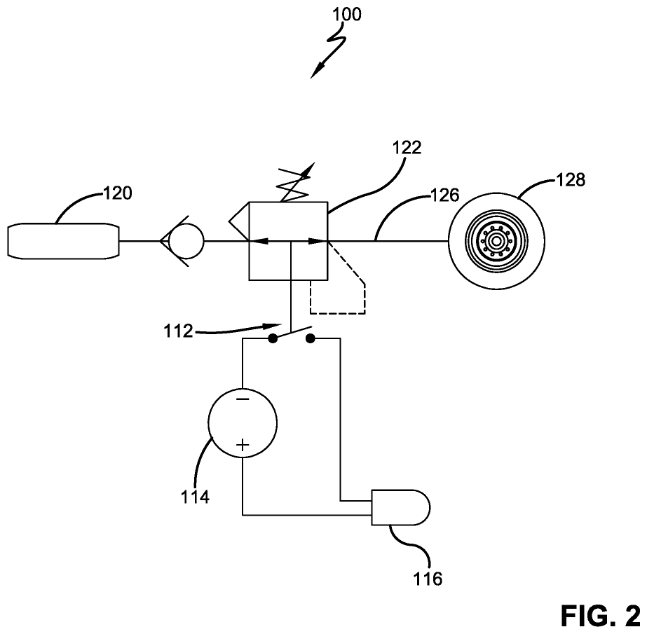

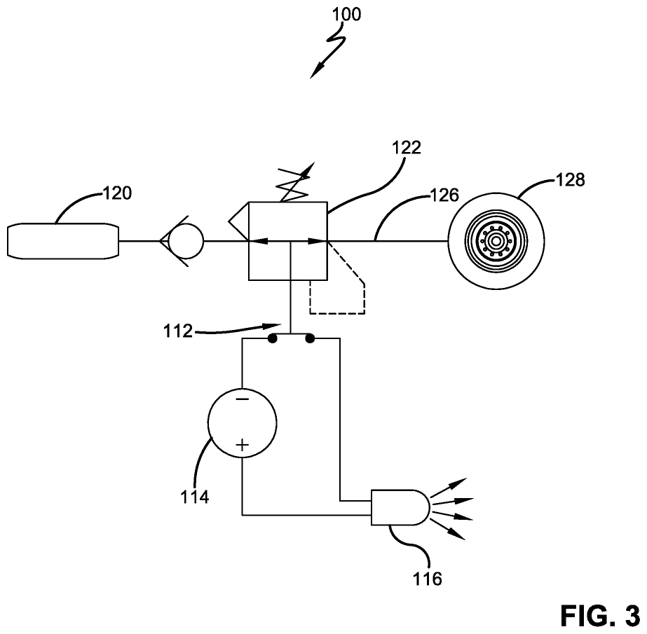

A tire inflation system 100 (FIGS. 2-3) , according to an aspect of the subject disclosure, includes a regulator 122 in fluid communication with a source of fluid pressure 120 and one or more tires 128 (only one shown) through a pressurized fluid path 126. The regulator 122 includes an external fluid flow regulator-actuated switch 112. The regulator 122 is operatively connected to the switch 112. Operation of the regulator 122 affects the condition of the switch 112. The switch 112 may be electrically connected to a voltage source 114 and an electronic computing unit or other communication system or an indicator or lamp 116. The lamp 116 provides an indication of the status or condition of the regulator 122 and the tire inflation system 100, for example, to an operator of the heavy-duty vehicle.

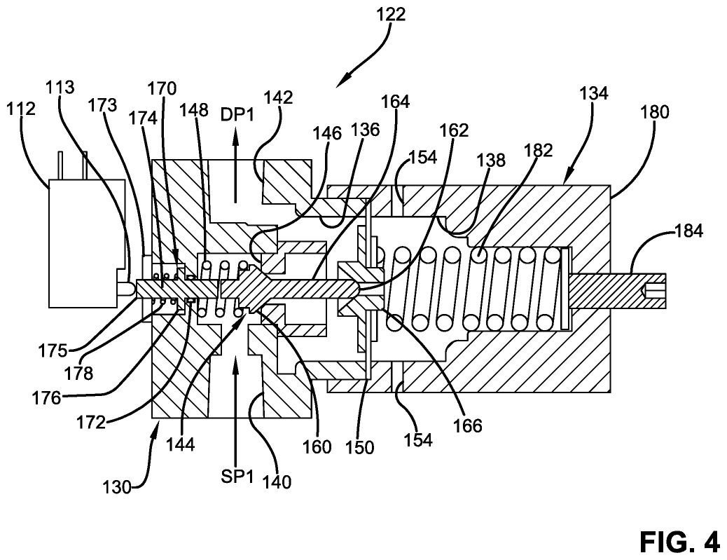

The regulator 122 includes a regulator section 130 (FIG. 4) and an adjustment section 134. The regulator section 130 and adjustment section 134 preferably have cylindrical inner surface portions 136, 138, respectively, defining respective cavities. The adjustment section 134 is attached to the regulator section 130, such that inner surface portions 136, 138 are arranged substantially coaxially. The adjustment section 134 may be attached to the regulator section 130 by any suitable means, such as a threaded connection. Alternatively, the regulator 122 may consist of any suitable number of components.

The regulator section 130 includes a fluid inlet port 140 into which supply pressure SP1 is directed from the source of fluid pressure 120. The regulator section 130 also includes a fluid outlet port 142 from which delivery pressure DP1 may flow through the fluid path 126 to the tires 128. A poppet valve arrangement 144 is supported in the regulator section 130. The poppet valve arrangement 144 has a supply portion 160 which selectively allows or blocks fluid communication between the fluid inlet port 140 and fluid outlet port 142. The poppet valve arrangement 144 also has a stem 164 and a movable exhaust seat 166. The stem 164 includes an exhaust end portion 162 that selectively allows or blocks fluid communication between the fluid outlet port 142 and the adjustment section 134. The adjustment section 134 has exhaust ports 154 located such that the exhaust ports are unrestricted and may freely communicate with atmosphere.

A diaphragm 150 is disposed between and separates the adjustment section 134 and the regulator section 130. The diaphragm 150 is attached or operatively connected to the exhaust seat 166. The diaphragm 150 establishes the position of the exhaust seat 166 and, thus, the poppet valve arrangement 144. As a result, the diaphragm establishes the fluid flow condition of the regulator 122. The exhaust seat 166 interacts with the exhaust end portion 162 of the stem 164 to selectively block or allow fluid flow between the regulator section 130 and the adjustment section 134. Movement of the exhaust seat 166 away from the exhaust portion 162 of the stem 164 allows fluid communication between the fluid outlet port 142 and the exhaust ports 154 to reduce the delivery pressure DP1. Movement of the exhaust seat 166 against the exhaust end portion 162 of the stem 164 forces the supply portion 160 away from a seat 146, allowing fluid communication only between fluid inlet port 140 and fluid outlet port 142 to increase the delivery pressure DP1. The poppet valve arrangement 144 is biased to a closed condition, as illustrated in FIG. 4, by a spring 148. The force applied by spring 148 is sufficient to hold the supply portion 160 against the seat 146 when the regulator 122 is in the closed condition. In the closed condition, the poppet valve arrangement 144 blocks fluid communication between the fluid inlet port 140 and the fluid outlet port 142.

The regulator section 130 supports a switch actuation mechanism 170. The switch actuation mechanism 170 has an actuating pin 174, which may form a part of, or abut, an end portion of, the poppet valve arrangement 144 axially opposite the exhaust portion 162. The actuating pin 174 extends through an O-ring seal 172 in an opening in the regulator section 130 and through an end cap 173, such that an end portion 175 of the actuating pin is disposed externally of the regulator 122. Alternatively, the end portion 175 of the actuating pin 174 may be disposed within the regulator section 130, the O-ring seal 172, and/or the end cap 173. The end cap 173 is suitably attached to the regulator section 130, such as by a threaded connection. The actuating pin 174 may include a collar 176, which interacts with the regulator section 130 and/or the end cap 173 to limit movement or travel of the actuating pin. A spring 178 is disposed about the actuating pin 174 between the regulator section 130 and the end cap 173, biasing the actuating pin to a first, or non-actuating, position in a direction toward the poppet valve arrangement 144 and against the regulator section.

The end portion 175 of the actuating pin 174 is adjacent to or abuts an actuable portion 113 of the normally-open switch 112. The switch 112 may be any suitable switching means, such as a microswitch, a reed switch, proximity switch, or any other electronic selectively actuated switching means. The switch 112 may be electrically connected to the voltage source 114 (FIGS. 2 and 3) and a device, such as an electronic control unit or other communication system or an indicator or lamp 116. The switch 112 may optionally and/or additionally provide an audible signal or other non-visual indication of the regulator 122 and tire inflation system 100. The end portion 175 of the actuating pin 174 may interact with the switch 112, such that the first position of the actuating pin exerts no force against the switch actuable portion 113 and corresponds to an open condition of the switch, as illustrated in FIG. 2. Once the bias of spring 178 is overcome, such as when fluid flow occurs through the regulator 122 between fluid inlet port 140 and fluid outlet port 142, the actuating pin 174 moves to a second position against the switch 112. In the second, or actuating, position, the actuating pin 174 extends farther externally from the regulator 122 toward the switch 112, actuating the switch into a closed condition, as illustrated in FIG. 3, which allows electrical power to illuminate the lamp 116. Movement of the actuating pin 174 between the first and second position corresponds to movement of the poppet valve arrangement 144 between closed and open conditions, respectively.

The adjustment section 134 includes a spring cap or bonnet 180 suitably attached, such as by a threaded connection, to the regulator section 130. An adjustment spring 182 is disposed within the bonnet 180. The adjustment spring 182 is operatively connected or attached to the diaphragm 150. An adjustment member 184 is threaded into the bonnet 180. Rotation of the adjustment member 184 engages and compresses the adjustment spring 182 against the diaphragm 150 and moves the exhaust seat 166, which moves the stem 164 to establish a target pressure at which the delivery pressure DP1 is maintained to the tires 128.

Forces generated by the adjustment spring 182 and the delivery pressure DP1 act on opposite sides of the diaphragm 150. As a result, the diaphragm 150 moves to a position where the forces from the adjustment spring 182 and the delivery pressure DP1 are in balance. In the event that the delivery pressure DP1 is below the target pressure, the adjustment spring 182 forces the diaphragm 150 to move the exhaust seat 166 in a direction that moves the poppet valve arrangement 144 into a filling condition. The filling condition of the poppet valve arrangement 144 allows fluid flow between the fluid inlet port 140 and fluid outlet port 142. As a result, the delivery pressure DP1 increases to the target pressure. When the poppet valve arrangement 144 is in the filling condition, the poppet valve arrangement applies force to the actuating pin 174. As a result, the actuating pin 174 overcomes the bias of spring 178 and moves to the second, or actuating, position and engages the switch actuable portion 113 and actuates the switch 112, moving the switch into an electrically closed condition. Electrical power may then flow from the voltage source 114 to the lamp 116, illuminating the lamp. Thus, the lamp 116 serves as an indication of fluid flow through the regulator 122 to the tires 128.

When the delivery pressure DP1 reaches the target pressure, the delivery pressure moves the supply portion 160, which causes the exhaust seat 166 and the diaphragm 150 to move against the adjustment spring 182. The supply portion 160 contacts the seat 146, blocking fluid flow between the fluid inlet port 140 and fluid outlet port 142. Thus, the regulator 122 maintains the delivery pressure DP1 at or near the target pressure. Closing the supply portion 160 reduces the force that the poppet valve arrangement 144 applies on the actuating pin 174, such that the actuating pin does not overcome the bias of spring 178. The actuating pin 174 moves into the regulator 122. The end portion 175 of the actuating pin 174 may no longer engage the actuable portion 113 of the switch 112 when the end portion returns to the first, or non-actuating, position. The switch 112, thus, returns to an electrically open condition when the end portion 175 of the actuating pin 174 is in the first, or non-actuating, position, preventing electrical power flow between the voltage source 114 and the lamp 116, such that the lamp is no longer illuminated.

Thus, the regulator 122 and regulator-actuated switch 112, according to an aspect of the subject disclosure, provide a flow detection device that is relatively economical, has increased sensitivity, and reduces or eliminates restriction of the fluid path 126. The regulator-actuated switch 112 is not exposed to moisture in the fluid path 126; so, the occurrence of inaccurate readings is reduced or eliminated.

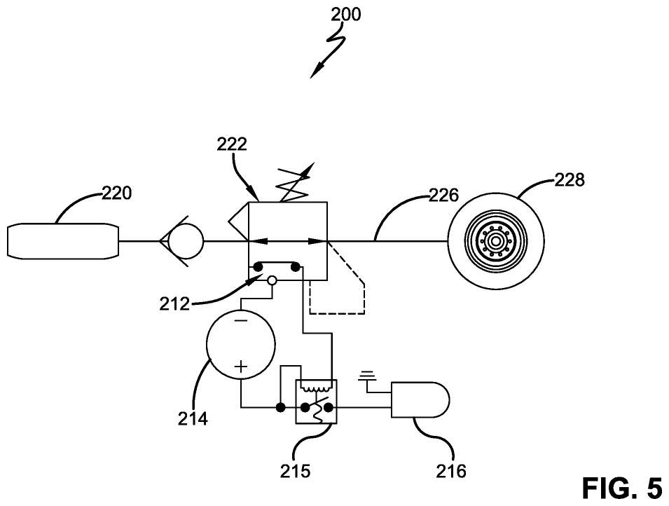

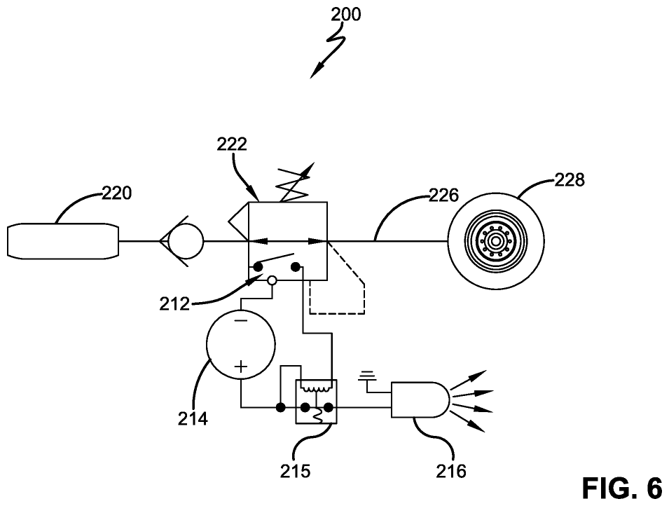

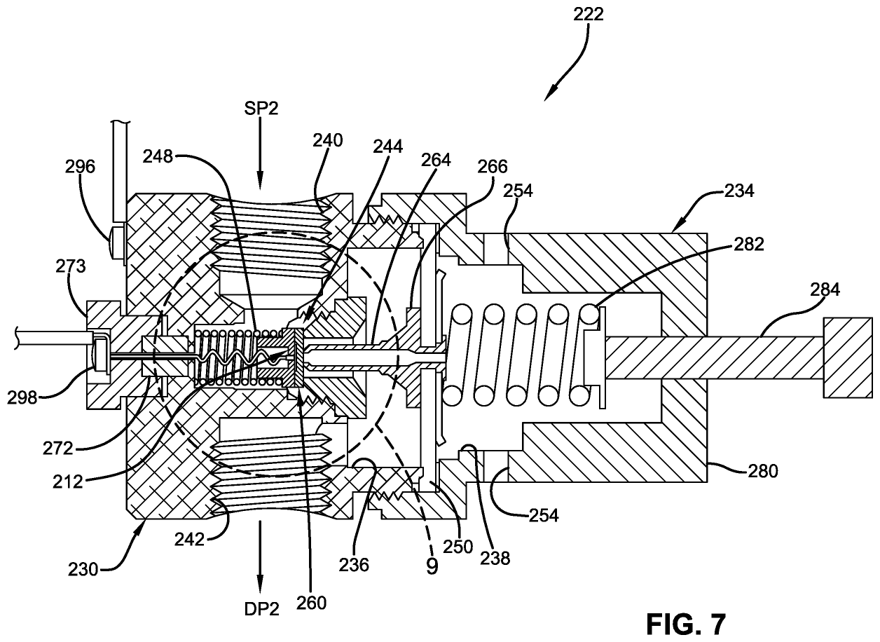

A tire inflation system 200, according to another aspect of the subject disclosure, is illustrated in FIGS. 5-6. The tire inflation system 200 includes a fluid flow regulator 222 with an integrated regulator-actuated contact or switch 212 (FIGS. 7-9). The regulator 222 is in fluid communication with a source of fluid pressure 220 and one or more tires 228 (only one shown) through a pressurized fluid path 226. The switch 212 is disposed within the regulator 222, such that operation of the regulator affects the condition of the switch. The switch 212 may be electrically connected to a voltage source 214 and an electronic control unit or other communication system or an indicator or lamp 216. The lamp 216 provides an indication of the status of the regulator 222, for example, to an operator of the heavy-duty vehicle.

The regulator 222 (FIG. 7) includes a regulator section 230 and an adjustment section 234. The regulator section 230 and the adjustment section 234 preferably have cylindrical inner surface portions 236, 238, respectively, defining respective cavities. The adjustment section 234 is attached to the regulator section 230, such that the inner surface portions 236, 238 are arranged substantially coaxially. The adjustment section 234 is attached to the regulator section 230 by any suitable means, such as a threaded connection. Alternatively, the regulator 222 may consist of any suitable number of components.

The regulator section 230 includes a fluid inlet port 240 into which supply pressure SP2 is directed from the source of fluid pressure 220. The regulator section 230 also includes a fluid outlet port 242 from which delivery pressure DP2 may flow to the tires 228. A poppet valve arrangement 244 is supported in the regulator section 230 between the fluid inlet port 240 and the fluid outlet port 242.

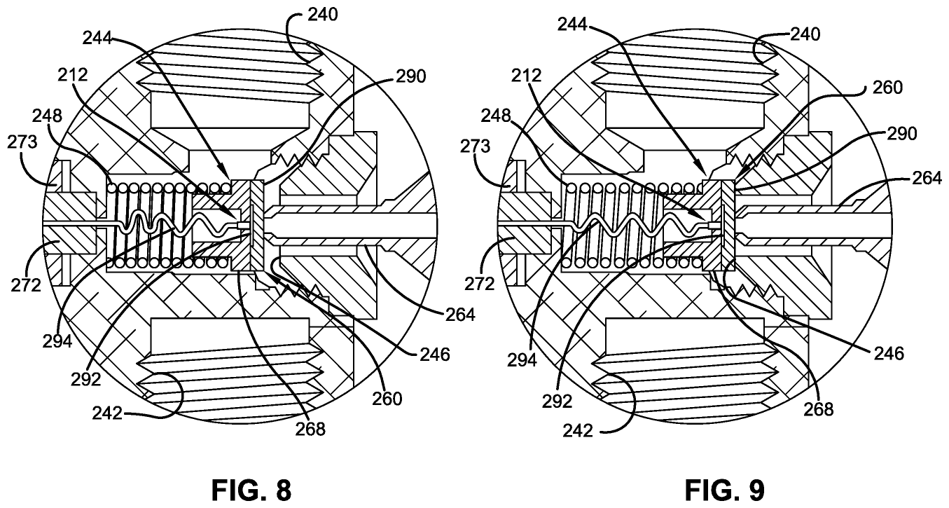

The poppet valve arrangement 244 has a supply portion 260 (FIGS. 7-9), which selectively allows or blocks fluid communication between the fluid inlet port 240 and fluid outlet port 242. The poppet valve arrangement 244 also has a hollow stem portion 264 extending from a collar 266. Movement of the collar 266 in a direction away from the adjustment section 234 forces the stem portion 264 against the supply portion 260 of the poppet valve arrangement 244, moving the supply portion away from a seat 246, as illustrated in FIG. 8. Movement of the supply portion 260 away from the seat 246 allows fluid communication between the fluid inlet port 240 and the fluid outlet port 242. The poppet valve arrangement 244 is biased by a spring 248 to a closed condition, as illustrated in FIG. 9, blocking fluid communication between the fluid inlet port 240 and the fluid outlet port 242. Specifically, the spring 248 forces the supply portion 260 against the stem portion 264 toward adjustment section 234, such that the supply portion presses against the seat 246, blocking fluid communication between fluid inlet port 240 and fluid outlet port 242.

The stem portion 264 also selectively allows or blocks fluid communication between the fluid outlet port 242 and the adjustment section 234. Specifically, movement of the collar 266 in a direction toward the adjustment section 234 moves the stem portion 264 of the poppet valve arrangement 244 independently away from the supply portion 260. Movement of the stem portion 264 away from the supply portion 260 creates an exhaust path through the hollow fluid path in the stem portion, which allows fluid communication between the fluid outlet port 242 and the adjustment section 234. The adjustment section 234 has exhaust ports 254, which are unrestricted and may freely communicate with atmosphere.

A diaphragm 250 (FIG. 7) is disposed between the adjustment section 234 and the regulator section 230. The collar 266 of the poppet valve arrangement 244 is disposed between the adjustment section 234 and the regulator section 230. The collar 266 is operatively connected to the diaphragm 250 for positioning by the diaphragm. The diaphragm 250 controls the position of the collar 266, such that the diaphragm controls the position and condition of the poppet valve arrangement 244.

The adjustment section 234 includes a spring cap or bonnet 280 suitably attached to the regulator section 230, such as by a threaded connection. An adjustment spring 282 is disposed within the bonnet 280. The adjustment spring 282 is operatively connected or attached to the diaphragm 250. An adjustment member 284 is threaded into the bonnet 280. Rotation of the adjustment member 284 engages and compresses the adjustment spring 282 against the diaphragm 250. The diaphragm forces the collar 266 with the stem portion 264 against the supply portion 260. The supply portion 260 moves away from the seat 246, allowing a target pressure for the delivery pressure DP2 to be established.

The poppet valve arrangement 244 of regulator 222 incorporates the integrated switch 212. The integrated switch 212 includes the seat 246 of the poppet valve arrangement 244. The seat 246 is conductive and may be formed from any suitable electrically conductive material, such as brass. Electrical power from the voltage source 214 (FIG. 5-6) is applied to the regulator 222 through a normally-closed relay 215 and a screw terminal 298. The regulator 222 or switch 212 may be grounded. Alternatively, the regulator 222 may be isolated in a non-conductive enclosure; coated with, or potted in, a dielectric paint or gel; and/or used with non-conductive components.

The integrated switch 212 also includes the supply portion 260 of the poppet valve arrangement 244. The supply portion 260 includes a conductive seal 290 (FIGS. 8-9). The conductive seal 290 is applied to or forms a part of the supply portion 260. The conductive seal 290 interacts with the seat 246 during operation of the regulator 222. A flat disc terminal 292 is disposed within the supply portion 260 and is in intimate contact with, and conducts electrical power to, the conductive seal 290. The supply portion 260 of the poppet valve arrangement 244 also includes a non-conductive housing 268. The non-conductive housing 268 is at least partially disposed within the spring 248. The non-conductive housing supports the conductive seal 290 and maintains the intimate contact between the conductive seal and the flat disc terminal 292. The non-conductive housing 268 isolates the flat disc terminal 292 from other components of the regulator 222 and switch 212. The flat disc terminal 292 is connected to a flexible insulated wire conductor 294 disposed within the housing 268 and spring 248. The conductor 294 extends through a rubber seal 272 (FIG. 7) and a threaded end cap 273 of the regulator section 230. The conductor 294 conducts electrical power to flat disc terminal 292 through the externally connected screw terminal 298 and the normally-closed relay 215 (FIG. 5).

Forces generated by the adjustment spring 282 and the delivery pressure DP2 act on opposite sides of the diaphragm 250. The diaphragm 250 moves the collar 266 to a position where the forces from the adjustment spring 282 and the delivery pressure DP2 are balanced. When the delivery pressure DP2 is greater than or equivalent to the target pressure, the supply portion 260 moves toward the seat 246 to an actuating position, blocking fluid flow between fluid inlet port 240 and fluid outlet port 242 and allowing the conductive seal 290 to contact the seat. The switch 212 is actuated or closed, as illustrated in FIGS. 5 and 9. Electrical power flows from the voltage source 214 (FIG. 5) through a magnetic coil in the relay 215, the screw terminal 298, the insulated conductor 294, the flat disc terminal 292, and the conductive seal 290 across the seat 246 through the body of the regulator 222 to screw terminal 296 (FIG. 7). The circuit with the voltage source 214 is completed, which energizes, and provides a ground path for, the relay 215. The energized relay 215 opens, preventing a connection between the voltage source 214 and the lamp 216, such that the lamp is not illuminated to indicate the lack of fluid flow through the regulator 222.

In the event that the delivery pressure DP2 is below the target pressure, the adjustment spring 282 forces the diaphragm 250 to move the collar 266 concurrently with the stem portion 264 against the supply portion 260 of the poppet valve arrangement 244. The supply portion 260 of poppet valve arrangement 244 is forced away from the seat 246 into an open condition, or non-actuating position, allowing fluid flow between the fluid inlet port 240 and fluid outlet port 242, which increases the delivery pressure DP2. The opening of the supply portion 260 breaks the connection between the seat 246 and the conductive seal 290, opening, or not actuating, the switch 212 (FIG. 8). The flow of electrical power between the voltage source 214 and the relay 215 ceases, allowing the relay to close (FIG. 6). Electrical power is conducted from the voltage source 214 to the lamp 216, illuminating the lamp. The lamp 216 serves as an indicator of fluid flow through the regulator 222. The increase in delivery pressure DP2 caused by the opening of the supply portion 260 causes the diaphragm 250 to apply a force against the adjustment spring 282. The supply portion 260 is forced into the closed condition by spring 248.

In the event that the delivery pressure DP2 is above the target pressure, the diaphragm 250 applies force to the adjustment spring 282, causing the stem portion 264 to move away from the supply portion 260. The hollow stem portion 264 allows fluid flow between the fluid outlet port 242 and the adjustment section 234 to the exhaust ports 254. As a result the delivery pressure DP2 decreases, to the target pressure. The supply portion 260 maintains contact between the seat 246 and the conductive seal 290. The flow of electrical power between the voltage source 214 and the relay 215 is uninterrupted, maintaining the relay in an open condition, such that the lamp 216 is not illuminated. The decrease in delivery pressure DP2 caused by the movement of the stem portion 264 away from the supply portion 260 causes the adjustment spring 282 to apply a force against the diaphragm 250. The stem portion 264 is forced against the supply portion 260, blocking fluid flow between the fluid outlet port 242 and the adjustment section 234. The regulator 222 can maintain a relatively constant delivery pressure DP2 at or near the target pressure.

Thus, the regulator 222 and integrated switch 212, according to an aspect of the subject disclosure, provide a flow detection device that is relatively economical; has increased sensitivity, accuracy, and reliability; and reduces or eliminates restriction of the fluid path 226.

It is to be understood that the structure of the fluid flow regulator 122, 222 with switch 112, 212 may be altered or rearranged, or certain components omitted or added, without affecting the overall concept or operation of the subject disclosure. For example, regulator 122, 222 may be mechanical/pneumatic or electric/electronic. The integrated switch 212 may be formed from other components of the poppet valve arrangement 244 or regulator 222. Moreover, regulator 122, 222 and switch 112, 212 may be incorporated into a tire inflation system employing other control valves or electronic control units.

The improved fluid flow regulator 122, 222 with the regulator-actuated switch 112, 212 of the subject disclosure is simplified, provides an effective, safe, economical, and efficient structure. The improved fluid flow regulator 122, 222 with the regulator-actuated switch 112, 212 of the subject disclosure overcomes the disadvantages, drawbacks, and limitations of prior art flow detectors and tire inflation systems, and solves problems and obtains new results in the art.

It is to be further understood that the subject disclosure may find application in other types of tire inflation systems for vehicles or pneumatic systems known to those skilled in the art without affecting the concept or operation of the subject disclosure. Moreover, gases or fluids other than air that may be compressed and follow the principles of fluid flow, including nitrogen, carbon dioxide, and the like, may be employed without affecting the concept or operation of the subject disclosure.

In the foregoing description, certain terms have been used for brevity, clarity, and understanding; but no unnecessary limitations are to be implied therefrom beyond the requirements of the prior art because such terms are used for descriptive purposes and are intended to be broadly construed. Although the description has been shown and described with respect to one or more aspects, applications, or implementations, it will occur to those skilled in the art based upon a reading and understanding of this description and the drawings that improvements, alterations, and modifications may be made without detracting from the spirit and scope of the aspects or implementations in the description. Such improvements, alterations, modifications, and equivalents within the skill of the art are intended to be covered by the appended claims.

Having now described the features, discoveries and principles of the invention, the manner in which the fluid flow regulator with switch is used and installed, the characteristics of the construction, arrangement and method steps, and the advantageous, new and useful results obtained; the new and useful structures, devices, elements, arrangements, process, parts and combinations are set forth in the appended claims.

What is claimed is:

1. A fluid flow regulator comprising:
a body;
an actuatable switch; and
valve structure disposed within the body, the valve structure having at least a portion movable between an actuating position and a non-actuating position, the switch being activated when the portion is in the actuating position, the switch not being activated when the portion is in the non-actuating position.

2. The fluid flow regulator of claim 1, wherein the portion is responsive to a change in fluid pressure.

3. The fluid flow regulator of claim 2, further including the portion of the valve structure further comprising a poppet.

4. The fluid flow regulator of claim 3, wherein the poppet moves to the actuating position in response a change in fluid pressure.

5. The fluid flow regulator of claim 4, further including the switch being external to the body.

6. The fluid flow regulator of claim 5, wherein the poppet is operatively connected to an actuator pin partially disposed externally of the body and operatively connected to the switch.

7. The fluid flow regulator of claim 6, wherein the switch is operatively connected to an indicator that is activated in response to actuation of the switch.

8. The fluid flow regulator of claim 3, wherein the poppet further comprises a conductive pneumatic seal.

9. The fluid flow regulator of claim 8, wherein the poppet moves to the non-actuating position in response to formation of a change in fluid pressure.

10. The fluid flow regulator of claim 9, wherein the switch comprises one or more components of the valve structure.

11. The fluid flow regulator of claim 10, wherein the one or more components of the valve structure comprise the poppet or a valve seat.

12. The fluid flow regulator of claim 11, wherein the switch is operatively connected to an indicator that is activated in response to the poppet moving to the non-actuating position.

13. A fluid flow regulator comprising:
a body;
an actuatable switch external to the regulator; and
valve structure disposed within the body, the valve structure having at least a portion movable between an actuating position and a non-actuating position, the portion actuating the switch in the actuating position, the portion not actuating the switch in the non-actuating position.

14. The fluid flow regulator of claim 13, further including the portion being operatively connected to an actuator pin at least partially disposed external to the body and operatively connected to the switch.

15. The fluid flow regulator of claim 14, wherein the actuator pin is adjacent the switch.

16. The fluid flow regulator of claim 15, wherein the actuator pin is movable to actuate the switch.

17. A fluid flow regulator comprising:
a body;
an actuatable switch disposed within the regulator; and
valve structure disposed within the body, the valve structure having at least a portion movable between an actuating position and a non-actuating position, the portion actuating the switch in the actuating position, the portion not actuating the switch in the non-actuating position.

18. The fluid flow regulator of claim 17, the switch comprising one or more components of the valve structure.

19. The fluid flow regulator of claim 18, the one or more components of the valve structure comprising at least one of a poppet and a valve seat.

20. The fluid flow regulator of claim 19, the poppet further comprising a conductive pneumatic seal.
